(19) United States
(12) Patent Application Publication
(10) Pub. No.: US 2010/0071722 A1
(43) Pub. Date: Mar. 25, 2010

(54) FILM ROLL, AND CLEANING METHOD FOR FILM DEPOSITING APPARATUS

(75) Inventor: Masami NAKAGAME, Kanagawa (JP)

Correspondence Address: YOUNG & THOMPSON, 209 Madison Street, Suite 500, Alexandria, VA, 22314, US

(73) Assignee: FUJIFILM Corporation, Tokyo (JP)

(21) Appl. No.: 12/564,223

(22) Filed: Sep. 22, 2009

(30) Foreign Application Priority Data
Sep. 22, 2008 (JP) 2008-243246

(51) Int. Cl. B08B 7/00; B08B 17/00; B05C 11/00

(52) U.S. Cl. 134/6; 118/72

(57) ABSTRACT

A film roll comprises an elongated substrate film for film deposition wound into a roll, the substrate film including: at least one elongated product-film portion having a pair of surfaces opposite with each other, with one of the surfaces serving as a surface for film deposition; and at least one cleaning-film portion connected to an end of the product-film portion and having a pair of surfaces opposite with each other, with at least one of the surfaces serving as a cleaning surface having a dust removal function.

### BACKGROUND OF THE INVENTION

The present invention relates to a method of cleaning a film depositing apparatus for forming a film on an elongated substrate in an atmosphere under vacuum while transporting the substrate by means of rollers, and to a film roll to be used for the film deposition and the cleaning on the film depositing apparatus. More particularly, the present invention is directed to a method of cleaning such a film depositing apparatus as above, which method enables an easy removal of dust particles adhering to the rollers transporting a substrate, and to a film roll to be used for the film deposition and the cleaning on the film depositing apparatus.

It is conventional to form an inorganic film continuously on the surface of an elongated substrate (a web of substrate) by a vapor deposition technique while transporting the substrate in an atmosphere under vacuum in a chamber.

During the conventional film deposition, dust particles which happen to adhere to the surface of the substrate on which a film to be formed will affect the evenness of the surface, leading to the generation of defects such as cracks and voids in the inorganic film formed. In this regard, JP 11-200045 A proposes preventing the defects due to adhesion of dust particles.

The above document discloses a cleaning method adapted for vacuum evaporation apparatus provided with a transport mechanism including guide rolls, in which method the guide rolls in an apparatus are cleaned under vacuum.

FIG. 3 of the document illustrates the cleaning method in which cleaning rolls each having a cleaning member wound around the relevant roll are brought into contact with the guide rolls from the outside of the apparatus, with each cleaning roll being made drivable to rotate.

In another method shown in FIG. 4 of the document, a cleaning mechanism allowing a cleaning member made of Miraclation (microfiber textile manufactured by Toray Industries, Inc.), Bemliese (nonwoven fabric manufactured by Asahi Kasei Corporation) or the like to move along is caused to work directly on the guide rolls in an on/off manner.

It is described in the document that, owing to such configurations as above, the surfaces of guide rolls can be cleaned so as to prevent dust particles from adhering to a film.

In the cleaning method disclosed in the above document, however, cleaning rolls must be brought into contact with guide rolls from the outside of an apparatus, or a cleaning mechanism allowing a cleaning member to move along must be caused to work directly on guide rolls in an on/off manner. In other words, it is required for the implementation of the disclosed cleaning method to provide the evaporation apparatus with multiple driving mechanisms, multiple, extra mechanisms in addition to the evaporation mechanism. Consequently, the apparatus enabling the cleaning method disclosed in JP 11-200045 A will be complicated in structure, which may increase the apparatus costs unfavorably.

### SUMMARY OF THE INVENTION

It is an object of the present invention to solve the above problems involved with the prior art so as to provide a method of cleaning a film depositing apparatus, which method enables an easy removal of dust particles adhering to the path rollers transporting a substrate film, and a film roll to be used for the film deposition and the cleaning on the film depositing apparatus.

A film roll according to the present invention comprises an elongated substrate film for film deposition wound into a roll, the substrate film including: at least one elongated product-film portion having a pair of surfaces opposite with each other, with one of the surfaces serving as a surface for film deposition; and at least one cleaning-film portion connected to an end of the product-film portion and having a pair of surfaces opposite with each other, with at least one of the surfaces serving as a cleaning surface having a dust removal function.

A cleaning method according to the present invention is a method of cleaning a film depositing apparatus for forming a specified film on a surface of an elongated substrate film in an atmosphere under vacuum while transporting the substrate film in its longitudinal direction by means of path rollers, the method comprising: using such a film roll; and transporting the cleaning-film portion of the substrate film of the film roll by means of the path rollers to thereby clean the path rollers.

### BRIEF DESCRIPTION OF THE DRAWINGS

FIG. 1 is a schematic diagram showing a film depositing apparatus which is cleaned by a cleaning method according to Embodiment 1 of the present invention.

FIG. 2 is a schematic diagram showing a film roll to be used for the film deposition and the cleaning on the film depositing apparatus shown in FIG. 1.

FIG. 3A is a schematic diagram showing a film roll according to Embodiment 2.

FIG. 3B is a schematic diagram showing a film roll according to Embodiment 3.

FIG. 3C is a schematic diagram partially showing a film roll according to a modification of Embodiment 3.

FIG. 4A is a schematic diagram showing a film roll according to Embodiment 4.

FIG. 4B is a schematic diagram showing a film roll according to a modification of Embodiment 4.

FIG. 5A is a schematic diagram showing a film roll according to Embodiment 5.

FIG. 5B is a schematic diagram showing a film roll according to a modification of Embodiment 5.

FIG. 5C is a schematic diagram showing a film roll according to another modification of Embodiment 5.

FIG. 6 is a schematic, perspective view of an example of the two-diameter roller which is cleaned effectively by using a film roll according to Embodiment 5.

### DETAILED DESCRIPTION OF THE INVENTION

On the following pages, the film roll and the film depositing apparatus cleaning method according to the present invention are described in detail with reference to the preferred embodiments shown in the accompanying drawings.

### Embodiment 1

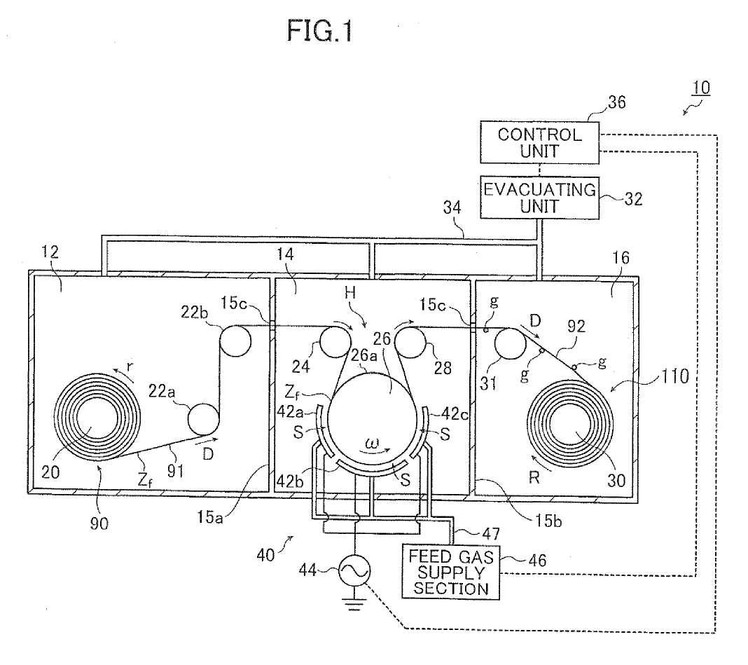

A film depositing apparatus 10 shown in FIG. 1 is a roll-to-roll type machine that forms an inorganic film or the like with a specified function on the front surface Zf of a product-film portion 94 of a substrate film 91, or on the top of one or more films such as organic layers which may have been formed on the front surface Zf of the product-film portion 94 of the substrate film 91; the film depositing apparatus 10 is typically employed to produce functional films such as an optical film or a gas barrier film.

In the case where one or more films such as organic layers have been formed on the front surface Zf of the substrate film 91, the surface of the film formed uppermost is assumed as the front surface Zf of the substrate film 91.

The film depositing apparatus 10 is an apparatus for continuously depositing a film on an elongated substrate film 91 (a web of substrate 91); it comprises basically a feed compartment 12 for feeding the elongated substrate film 91, a film depositing compartment (vacuum vessel) 14 for forming a film on the elongated substrate film 91, a take-up compartment 16 for winding up the elongated substrate film 91 on which the film has been formed, an evacuating unit 32, and a control unit 36. The control unit 36 controls the actions of the individual elements of the film depositing apparatus 10.

In the film depositing apparatus 10, the feed compartment 12 and the film depositing compartment 14 are separated from each other by a wall 15a, and the film depositing compartment 14 and the take-up compartment 16 are separated from each other by a wall 15b; a slit of opening 15c through which the substrate film 91 can pass is formed in each of the walls 15a and 15b.

In the film depositing apparatus 10, each of the feed compartment 12, the film depositing compartment 14 and the take-up compartment 16 is connected to the evacuating unit 32 via a piping system 34. The evacuating unit 32 creates a specified degree of vacuum, that is to say, a specified pressure, in the interiors of the feed compartment 12, the film depositing compartment 14, and the take-up compartment 16.

To evacuate the feed compartment 12, the film depositing compartment 14 and the take-up compartment 16 to maintain a specified degree of vacuum, the evacuating unit 32 has vacuum pumps such as a dry pump and a turbo-molecular pump. Each of the feed compartment 12, the film depositing compartment 14 and the take-up compartment 16 is equipped with a pressure sensor (not shown) for measuring the internal pressure.

Note that the ultimate degree of vacuum that should be created in the feed compartment 12, the film depositing compartment 14 and the take-up compartment 16 by the evacuating unit 32 is not particularly limited as long as the degree of vacuum is kept adequate in accordance with such factors as the method of film deposition to be performed, that is to say, the pressure is made suitable for the method of film deposition to be performed. The evacuating unit 32 is controlled by the control unit 36.

The feed compartment 12 is a site for the feeding of the elongated substrate film 91, and is provided with a rotatable delivery shaft 20 on which a substrate roll (film roll) 90 is to be mounted, a first guide roller 22a, and a second guide roller 22b.

The rotatable delivery shaft 20 allows the elongated substrate film 91 to be continuously delivered from the substrate roll 90 mounted on the shaft 20. The substrate roll 90 is actually the substrate film 91 that has been wound into a roll.

The rotatable delivery shaft 20 is typically connected with a motor (not shown) as a drive source. The delivery shaft 20 rotated by the motor causes rotation of the substrate roll 90 in a direction r in which the substrate film 91 is unwound; in the embodiment under consideration, the substrate roll 90 is rotated counterclockwise in the figure so as to deliver the substrate film 91 continuously.

The first guide roller 22a and the second guide roller 22b guide the substrate film 91 along a specified transport path into the film depositing compartment 14. The first guide roller 22a and the second guide roller 22b are each composed of a known guide roller.

In the film depositing apparatus 10 of this embodiment, the first and second guide rollers 22a and 22b may be driving rollers or driven rollers. In addition, the first and second guide rollers 22a and 22b may serve as tension rollers for adjusting the tension during transportation of the substrate film 91.

The film depositing compartment 14 functions as a vacuum vessel (vacuum chamber), and is a site where an inorganic film is continuously formed on the front surface Zf of the substrate film 91 by a vapor-phase film deposition technique, typically by plasma-enhanced CVD, as the substrate film 91 is being transported.

Walls surrounding the film depositing compartment 14 are constructed by using a material which is commonly employed in a variety of vacuum chambers, such as stainless steel, aluminum, or an aluminum alloy.

The film depositing compartment 14 is provided with two guide rollers 24 and 28, as well as a drum 26 and a film depositing unit 40.

The guide rollers 24 and 28 are spaced apart parallel to each other in a face-to-face relationship; they are also provided in such a way that their longitudinal axes cross at right angles to a direction D in which the substrate film 91 is transported.

The guide roller 24 transports the substrate film 91 delivered from the second guide roller 22b in the feed compartment 12 to the drum 26. The guide roller 24 is rotatable, typically having an axis of rotation in a direction perpendicular to the transport direction D of the substrate film 91 (this direction being hereafter referred to as the axial direction), and its length in the axial direction is greater than the length of the substrate film 91 in the width direction perpendicular to the longitudinal direction (the latter length being hereafter referred to as the width of the substrate film 91).

The guide roller 28 transports the substrate film 91 wrapped around the drum 26 to a guide roller 31 provided in the take-up compartment 16. The guide roller 28 is rotatable, typically having an axis of rotation in the axial direction, and its length in the axial direction is greater than the width of the substrate film 91.

The guide rollers 24 and 28 are identical to the first and second guide rollers 22a and 22b provided in the feed compartment 12 in configuration except for the above, so that no further explanation will be given on them.

The drum 26 is provided below the space H between the guide rollers 24 and 28. The drum 26 is so positioned that its longitudinal axis is parallel to those of the guide rollers 24 and 28. In addition, the drum 26 is electrically connected to the ground.

The drum 26 typically assumes a cylindrical shape and has an axis of rotation (not shown). The drum 26 is capable of rotating in the direction of rotation ω about the axis of rotation, and the length of the drum 26 in the axial direction is greater than the width of the substrate film 91. The drum 26, as having a surface 26a (peripheral surface) with which the substrate film 91 wrapped around the drum 26 is in contact, is rotated so as to transport the substrate film 91 in the transport direction D while holding it in a specified film depositing position.

For temperature adjustment, the drum 26 may be provided in its center with a heater (not shown) for heating the drum 26 and a temperature sensor (also not shown) for measuring the temperature of the drum 26. In that case, the heater and the temperature sensor are connected to the control unit 36 which adjusts the temperature of the drum 26 such that it is maintained as specified.

The film depositing unit 40 is provided below the drum 26, and typically forms an inorganic film on the front surface Zf of the substrate film 91 which, as being wrapped around the drum 26, is being transported in the transport direction D by the drum 26 rotated in the direction of rotation ω.

It should be noted that the substrate film 91 after film deposition having an inorganic film formed on the front surface Zf of the product-film portion 94 thereof will also be referred to as a functional film if it exercises a specified function, such as a function of hardly permitting gas permeation, as a result of the formation of a specified inorganic film.

The film depositing unit 40 is adapted to form an inorganic film typically by capacitively coupled plasma enhanced CVD (CCP-CVD). The film depositing unit 40 has film depositing electrodes, which are typically three in number and are indicated by 42a, 42b and 42c in the figure, as well as a radio-frequency power source 44 and a feed gas supply section 46. The control unit 36 controls the radio-frequency power source 44 and the feed gas supply section 46 in the film depositing unit 40.

In the film depositing unit 40, the three film depositing electrodes 42a to 42c are provided in the lower part of the film depositing compartment 14 such that they are located apart from the surface 26a of the drum 26 with a specified gap S.

The film depositing electrodes 42a to 42c are each formed of a curved rectangular member, and are arranged along the direction of rotation ω as if to follow the surface 26a of the drum 26, with their long sides being parallel to the axis of rotation of the drum 26.

In this embodiment, the film depositing electrodes 42a to 42c are typically curved with a specified curvature so that they may align with a circle concentric with the surface 26a of the drum 26. The film depositing electrodes 42a to 42c are each positioned so that the distance between the surface of a given part of the relevant electrode and the surface 26a of the drum 26 may always be as specified, with the distance being measured on the line which is perpendicular to the surface of the part and passes through the center of rotation of the drum 26.

In this embodiment, the film depositing electrodes 42a to 42c are each curved to follow the surface 26a of the drum 26, but this is not the sole case of the present invention and a rectangular member may be bent in an angular shape; alternatively, a number of flat rectangular electrode plates may be arranged along the direction of rotation ω as if to follow the surface 26a of the drum 26.

To the film depositing electrodes 42a to 42c is connected the radio-frequency power source 44 which applies a radio-frequency voltage to the individual film depositing electrodes 42a to 42c. The radio-frequency power source 44 is capable of varying the radio-frequency power (RF power) to be applied. The film depositing electrodes 42a to 42c and the radio-frequency power source 44 may optionally be connected to each other via a matching box in order to attain impedance matching.

The film depositing electrodes 42a to 42c are each an electrode of a type generally called “a shower head electrode” and each of the film depositing electrodes 42a to 42c has a plurality of through-holes (not shown) formed in its surface at regular intervals. By means of the film depositing electrodes 42a to 42c, the feed gas G is supplied uniformly into the gap S.

The feed gas supply section 46 supplies the feed gas G for film formation into the gap S via a piping system 47 and through the through-holes formed in the surfaces of the film depositing electrodes 42a to 42c.

The feed gas G is uniformly supplied from the feed gas supply section 46 into the gap S via the piping system 47 and the through-holes in the surfaces of the film depositing electrodes 42a to 42c.

The gap S between the surface 26a of the drum 26 and the film depositing electrodes 42a to 42c serves as a space where plasma is to be generated, hence, as a film deposition space.

In the embodiment under consideration, if a SiO₂ film is to be formed, the feed gas G is a TEOS gas, with oxygen gas being used as an active species gas. If a silicon nitride film is to be formed, SiH₄ gas, NH₃ gas and N₂ gas (dilution gas) are used. In this embodiment, even a feed gas containing an active species gas and a dilution gas is simply referred to as a feed gas.

The feed gas supply section 46 may be chosen from a variety of gas introducing means that are employed in CVD apparatus.

In addition, the feed gas supply section 46 may supply into the gap S not only the feed gas G but also an inert gas such as argon or nitrogen gas, an active species gas such as oxygen gas, and various other gases that are used in CVD. In the case of introducing more than one species of gas, the respective gases may be mixed together in the same piping system and the mixture be supplied into the gap S through the holes of the film depositing electrodes 42a to 42c; alternatively, the respective gases may be supplied via different piping systems and through the holes of the film depositing electrodes 42a to 42c into the gap S.

The kinds of the feed gas, the inert gas and the active species gas, as well as the amounts in which they are introduced may be chosen and set as appropriate for various considerations including the kind of the film to be formed and the desired film deposition rate.

Note that the radio-frequency power source 44 may be of any known type that is employed in film deposition by plasma-enhanced CVD. The maximum power output and other characteristics of the radio-frequency power source 44 are not particularly limited and may be chosen and set as appropriate for various considerations including the kind of the film to be formed and the desired film deposition rate.

The film depositing electrodes 42a to 42c are in no way limited to such a configuration that a rectangular member is curved, and various other electrode configurations may be adopted as long as they allow film deposition by CVD; to give one example, electrode segments arranged in the axial direction of the drum 26 are thinkable.

While the film depositing electrodes 42a to 42c each have a plurality of through-holes formed in their surfaces, any other structure may be given to the electrodes as long as the feed gas G can uniformly be supplied into the gap S serving as the film deposition space. For instance, the film depositing electrodes 42a to 42c may have slit-shaped openings formed in their surfaces such that the feed gas G is discharged through the openings.

The take-up compartment 16 is a site where the substrate film 91 with an inorganic film formed on the front surface Zf in the film depositing compartment 14 is wound up; it is provided with a take-up shaft 30 and a guide roller 31.

The take-up shaft 30 is used for winding up the substrate film 91 having a film deposited thereon into a roll. The take-up shaft 30 is typically connected with a motor (not shown) as a drive source. By means of the motor, the take-up shaft 30 is rotated so as to wind up the substrate film 91 after film deposition. The substrate film 91 after film deposition that is being wound up by the take-up shaft 30, typically around a core mounted on the shaft 30, is shown as a film roll after film deposition 110.

It should be noted that the film roll after film deposition 110 includes not only the substrate film 91 after film deposition that is being wound up by the take-up shaft 30, but the substrate film 91 after film deposition that has been wound into a roll. The take-up shaft 30 is rotated by the motor clockwise in the figure so as to wind up the substrate film 91 after film deposition continuously.

The film roll after film deposition 110 will also be referred to as a functional film roll if the substrate film 91 to be wound up is a functional film as stated before.

The guide roller 31 guides the substrate film 91, which is transported from the film depositing compartment 14, along a specified transport path to the take-up shaft 30. The guide roller 31 is composed of a known guide roller. The guide roller 31 may be a driving roller or driven roller as is the case with the first and second guide rollers 22a and 22b in the feed compartment 12. In addition, the guide roller 31 may serve as a tension roller.

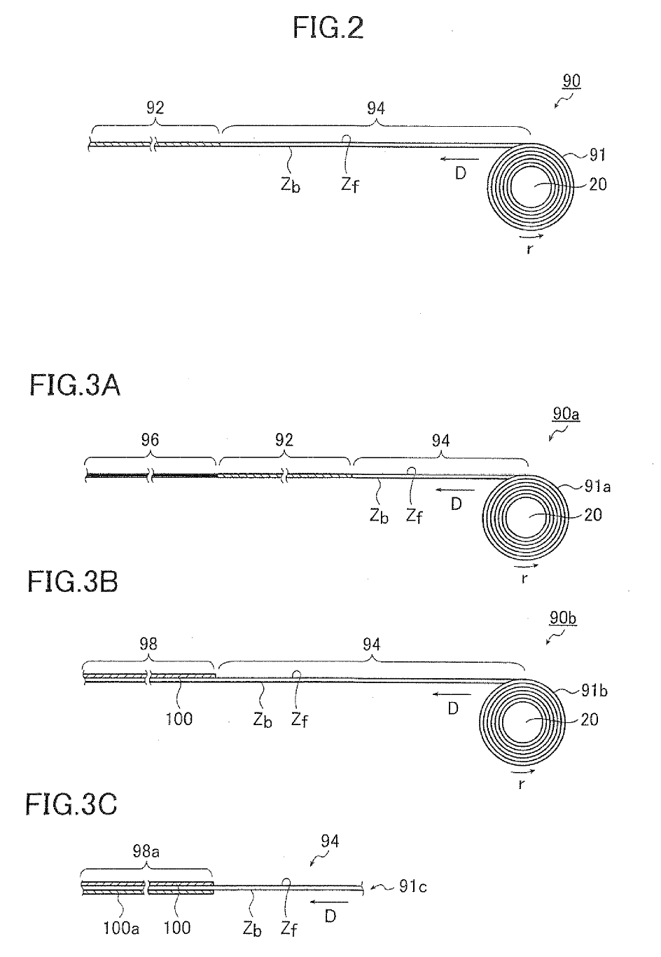

As shown in FIG. 2, the substrate film 91 has a cleaning-film portion 92 as well as the product-film portion 94 on which an inorganic film is to be formed. The cleaning-film portion 92 and the product-film portion 94 are substantially identical in thickness. The cleaning-film portion 92 is integrally joined to the front end of the product-film portion 94.

The substrate film 91 is typically wound around a cylindrical core, starting with the rear end of the product-film portion 94, into a roll and, as such, constitutes the substrate roll 90. In that case, the cleaning-film portion 92 is located near to the surface, namely outer periphery, of the substrate roll 90. When the substrate film 91 is drawn from the substrate roll 90 in the transport direction D, there comes the cleaning-film portion 92 initially, then the product-film portion 94.

The cleaning-film portion 92 is used for cleaning a variety of path rollers (the first guide roller 22a, the second guide roller 22b, the guide roller 24, the drum 26, the guide roller 28, and the guide roller 31) in the film depositing apparatus 10 by removing the dust particles adhering to the path rollers.

The cleaning-film portion 92 has a dust removal function (cleaning function), namely a function of removing the dust particles adhering to a variety of path rollers in the film depositing apparatus 10, at least on its surface which is on the same side as the surface for film deposition (front surface Zf) of the product-film portion 94 on which an inorganic film is to be formed.

For the cleaning-film portion 92, adhesive tapes for dust removal in a clean room are typically employed. Examples of the adhesive tape to be employed include Ridged Clean (trade name) manufactured by SAKURAI CO., LTD. and SOMATAC® WA (trade name) manufactured by SOMAR Corporation.

In the cleaning-film portion 92, the dust removal function is not limited to the surface on the same side as the front surface Zf for film deposition of the product-film portion 94 but preferably also possessed by the surface on the side where the back surface Zb, on which no film is deposited, is present. The dust removal function exercised not only on the front surface Zf's side but the back surface Zb's side prevents the adhesion of dust particles to the back surface Zb of the portion 94 of the substrate film 91, which protects the inorganic film deposited on the substrate from being scratched by the dust particles adhering to the back surface Zb when the substrate is wound up by the take-up shaft 30.

The cleaning-film portion 92 has a length appropriately specified depending on the entire path length (entire length of the transport path) as well as the size and number of the path rollers in the film depositing apparatus 10.

The cleaning-film portion 92 is preferably so long that all the path rollers in the film depositing apparatus 10 may do at least one turn when the cleaning-film portion 92, as being drawn form the substrate roll 90 mounted on the rotatable delivery shaft 20, then caused to pass through the transport path to the take-up shaft 30 via the first guide roller 22a, the second guide roller 22b, the guide roller 24, the drum 26 and the guide roller 28 in the film depositing compartment 14, as well as the guide roller 31 in the take-up compartment 16, has been wound up by the rotated take-up shaft 30.

Removal of dust particles from the path rollers by the cleaning-film portion 92 of the substrate roll 90 makes it possible to prevent the adhesion of dust particles to the product-film portion 94 at least in terms of its front surface Zf for film deposition.

In this embodiment, the product-film portion 94 of the substrate film 91 is not particularly limited, and any type of substrate may be used as the portion 94 as long as a film can be formed on it by a vapor-phase film deposition technique. Examples of the material usable as the product-film portion 94 of the substrate film 91 include a variety of resin films such as a PET film and a PEN film as well as various metal sheets such as an aluminum sheet.

The product-film portion 94 of the substrate film 91 may also be composed of the PET film, PEN film or other resin film as the base film on which one or more thin layers of organic matter are formed.

The following description is made on the method of depositing a film with the film depositing apparatus 10 using the substrate roll 90 of the embodiment under consideration, and on the cleaning method performed on the apparatus 10.

In the film depositing apparatus 10, the elongated substrate film 91 is initially wound off from the substrate roll 90 typically rotated counterclockwise in the figure, then transported into the film depositing compartment 14 via the first and second guide rollers 22a and 22b. In the film depositing compartment 14, the substrate film 91 passes over the guide roller 24, the drum 26 and the guide roller 28 to be transported into the take-up compartment 16. In the take-up compartment 16, the cleaning-film portion 92 at the front end of the substrate film 91 that has reached the take-up shaft 30 via the guide roller 31 is fixed to the shaft 30, which makes the take-up shaft 30 ready to wind up the substrate 91.

After the elongated substrate film 91 is thus positioned in the transport path, a specified degree of vacuum is created and maintained by the evacuating unit 32 in the interiors of the feed compartment 12, the film depositing compartment 14 and the take-up compartment 16. Then, the take-up shaft 30 is rotated clockwise in the figure (in the direction R). The dust particles g adhering to the path rollers now adhere to the cleaning-film portion 92, that is to say, the particles g are removed from the path rollers. As a result, the adhesion (transfer) of dust particles to the front surface Zf as the surface for film deposition as well as the back surface Zb of the product-film portion 94 is prevented.

Subsequently, under such conditions that the entire cleaning-film portion 92 has been wound up by the take-up shaft 30 and the vacuum created in the interiors of the feed compartment 12, the film depositing compartment 14 and the take-up compartment 16 is still maintained by the evacuating unit 32, the film depositing unit 40 is so operated that a radio-frequency voltage may be applied by the radio-frequency power source 44 to the film depositing electrodes 42a to 42c and the feed gas G may be supplied from the feed gas supply section 46 to the gap S via the piping system 47, supplied uniformly through the holes formed in the surfaces of the film depositing electrodes 42a to 42c.

When electromagnetic waves are radiated around the film depositing electrodes 42a to 42c, a plasma localized in the neighborhood of the film depositing electrodes 42a to 42c is generated in the gap S (film deposition space), whereupon the feed gas G is excited and dissociated to yield a reaction product that serves to form a film. The reaction product is deposited on the surface for film deposition (front surface Zf) of the product-film portion 94 of the substrate film 91 within the areas corresponding to the film depositing electrodes 42a to 42c so as to form an inorganic film of a specified thickness.

The process for film deposition is as follows: The elongated substrate film 91 is continuously delivered from the substrate roll 90 by rotating the delivery shaft 20 counterclockwise in the figure by a motor. The substrate film 91 is held on the drum 26 so that the product-film portion 94 may be where the plasma is to be generated. The drum 26 is rotated at a specified speed, and an inorganic film of a specified thickness is formed, by the film depositing unit 40, continuously on the front surface Zf of the product-film portion 94 transported.

The substrate film 91 having the film formed on the front surface Zf of the product-film portion 94 is transported to the take-up shaft 30 via the guide rollers 28 and 31, and wound up by the shaft 30 into the film roll after film deposition 110.

In the embodiment under consideration, dust particles are removed from the path rollers in an atmosphere under vacuum without opening up to the air, so that the adhesion of dust particles to the surface for film deposition, which may cause such defects as voids and cracks in the inorganic film formed, is prevented from occurring. Consequently, an inorganic film of a specified thickness can be formed as a film of good quality involving no defects continuously on the front surface Zf of the product-film portion 94 of the substrate film 91.

Moreover, cleaning of the film depositing apparatus 10 is carried out with such a simple configuration that the cleaning-film portion 92 is provided at the front end of the product-film portion 94 which is to be made into a functional film. This embodiment does not require any additional driving mechanism or the like, so that a complicated structure of the apparatus and increased apparatus costs are both avoided.

In this embodiment, the cleaning-film portion 92 may be transported at a speed different from the speed at which the product-film portion 94 is transported. In that case, the cleaning-film portion 92 is preferably transported at a lower speed than the product-film portion 94 in order to increase the particle removal rate. If the length of the cleaning-film portion 92 is already known, the transport speed can be changed when the product-film portion 94 begins being delivered, based on the relationship between the transport speed and the transport time.

The cleaning-film portion 92 may also be transported under a tension different from the tension under which the product-film portion 94 is transported. In that case, the cleaning-film portion 92 is preferably transported under a higher tension than the product-film portion 94 in order to increase the particle removal rate. If the length of the cleaning-film portion 92 is already known, the tension during transport can be changed when the product-film portion 94 begins being delivered, based on the relationship between the transport speed and the transport time. The tension during transport can be adjusted by modifying the torque of the rotatable delivery shaft 20 delivering the substrate film 91 and that of the take-up shaft 30 winding up the film 91.

### Embodiment 2

While the configuration of Embodiment 1 is such that the substrate film 91 consists of the cleaning-film portion 92 and the product-film portion 94 as shown in FIG. 2, the present invention is not limited to such a configuration. The exemplary configurations as described below have the same effects as the substrate roll 90 of Embodiment 1 that is composed of the substrate film 91 wound into a roll.

For instance, FIG. 3A shows a substrate roll 90a composed of a substrate film 91a wound into a roll, which has not only the cleaning-film portion 92 and the product-film portion 94 but a leader film 96 provided at the front end of the cleaning-film portion 92, that is to say, on the outer periphery of the roll 90a.

The leader film 96 typically has the thickness which is substantially the same as that of the cleaning-film portion 92, and is joined to the end of the cleaning-film portion 92. The leader film 96 may be made of the same material as the product-film portion 94, with the material including a PET film and a PEN film. Preferably, the leader film 96 has a length equal to or larger than the path length (length of the transport path) in the film depositing apparatus 10.

Upon cleaning of the film depositing apparatus 10, the substrate film 91a is stably transported owing to the leader film 96 provided as above, and the dust particles adhering to the path rollers can be removed by the cleaning-film portion 92 in such a stable situation.

In consequence, the product-film portion 94 is subjected to film deposition with a high transport stability, leading to the formation of a film of better quality.

### Embodiment 3

A substrate film may be composed of the product-film portion 94 by itself, as is the case with a substrate film 91b of a substrate roll 90b shown in FIG. 3B. The product-film portion 94 of the substrate film 91b has a cleaning section 98 provided on its surface for film deposition (front surface Zf) in the region of the front end as seen in the transport direction D, instead of the cleaning-film portion 92 of the substrate film 91 shown in FIG. 2. The cleaning section 98 is provided by forming a cleaning layer 100 having a cleaning function on the surface for film deposition (front surface Zf) of the product-film portion 94.

The cleaning layer 100 has the same functions as the cleaning-film portion 92. The cleaning section 98 is provided typically by affixing an adhesive layer to the front surface Zf of the product-film portion 94.

Similar to the substrate roll 90 of FIG. 2, the substrate roll 90b composed of the substrate film 91b wound into a roll serves to clean the film depositing apparatus 10, with the same effects being achieved.

A cleaning layer may be formed not only on the surface for film deposition (front surface Zf) but the back surface Zb. FIG. 3C shows a substrate film 91c which has a cleaning section 98a with a cleaning layer 100a formed on the back surface Zb as well as the cleaning layer 100 on the front surface Zf, unlike the substrate film 91b of FIG. 3B with the sole cleaning layer 100 on the front surface Zf. The cleaning layer 100a is identical to the cleaning layer 100 in configuration, so that no further explanation will be given on it.

It should be noted that the substrate film 91b of FIG. 3B may have the leader film 96 provided at the front end of the cleaning section 98 and, similarly, the substrate film 91c of FIG. 3C may have the leader film 96 provided at the front end of the cleaning section 98a.

### Embodiment 4

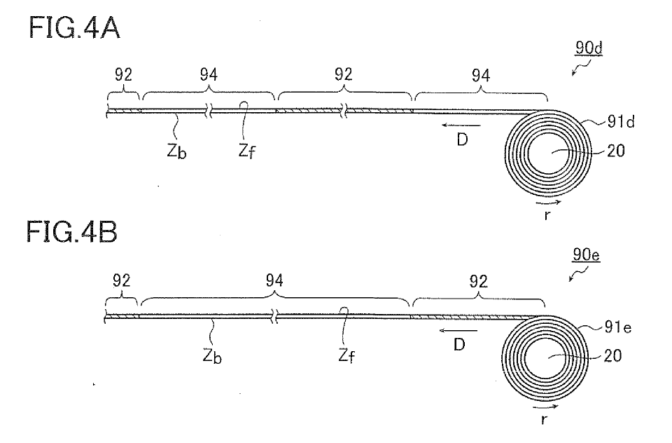

The cleaning-film portion 92 and the product-film portion 94 may each be two or more in number. FIG. 4A shows a film roll 90d composed of a substrate film 91d wound into a roll, in which one cleaning-film portion 92 is provided between two product-film portions 94 having specified lengths in addition to the portion 92 located at the front end of the film 91d. As evident from the shown example, it is possible to arrange a plurality of cleaning-film portions 92 of a specified length and a plurality of product-film portions 94 of a specified length in an alternating manner.

With such a configuration, every product-film portion 94 is subjected to film deposition after the removal of the dust particles and so forth which were generated and adhered to the path rollers during the preceding film deposition.

It is also possible to provide the cleaning-film portion 92 not only at the front end of the product-film portion 94 as seen in the transport direction D but also at the rear end thereof, that is to say, near to the inner periphery of the film roll, as is the case with a substrate film 91e of a film roll 90e shown in FIG. 4B.

When the entire substrate film 91e is wound up by the take-up shaft 30, the dust particles and so forth generated and adhering to the path rollers during film deposition are removed. In consequence, the film depositing apparatus 10 does not need a previous cleaning upon a next film deposition.

If the cleaning-film portion 92 is provided at the rear end of the product-film portion 94 as seen in the transport direction D, the film depositing apparatus 10 may be opened up to the air after the film deposition on the product-film portion 94 is completed, and the cleaning-film portion 92 may then be transported so as to remove the dust particles adhering to the path rollers, including those which adhere upon the opening up to the air.

The substrate film 91d of FIG. 4A and the substrate film 91e of FIG. 4B may each have the leader film 96 provided at the front end of the cleaning-film portion 92 which is located in the front of the relevant substrate film.

### Embodiment 5

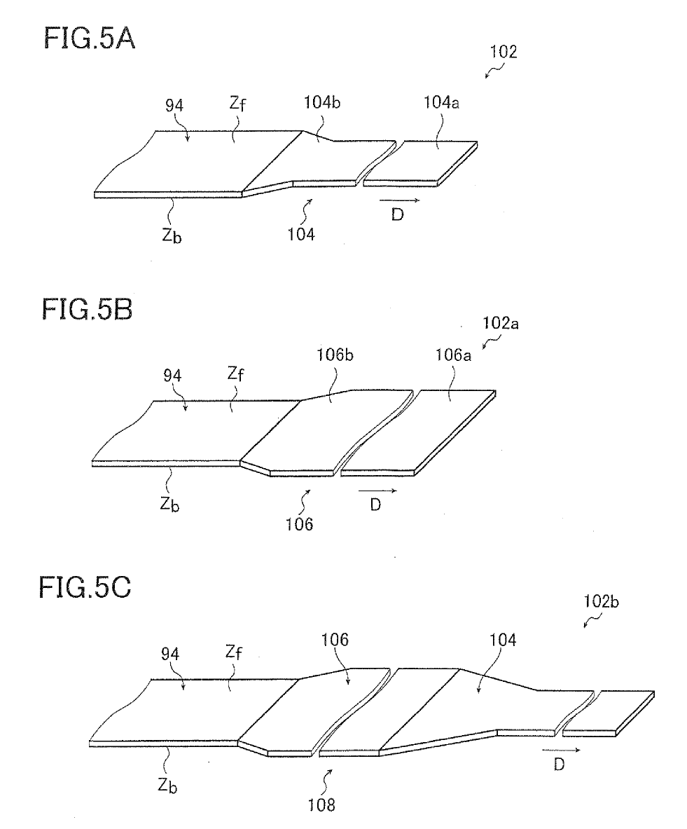

While the substrate film 91 of FIG. 2 has the cleaning-film portion 92 and the product-film portion 94 which are the same in width, the present invention is not limited to such a configuration. FIG. 5A shows a substrate film 102 which has a cleaning-film portion 104 with a smaller width than the product-film portion 94.

The cleaning-film portion 104 has the same functions and is made of the same material as the cleaning-film portion 92 of the substrate film 91 shown in FIG. 2.

The cleaning-film portion 104 is composed of a narrow part 104a with a smaller width than the product-film portion 94, and a joint part 104b connecting the narrow part 104a and the product-film portion 94 with each other.

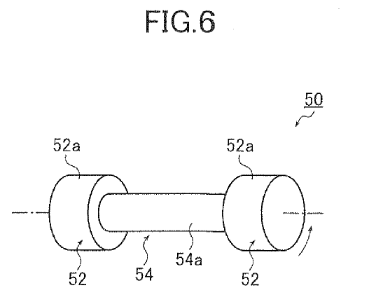

If the path rollers include a two-diameter roller 50 shown in FIG. 6 which has roller portions 52 and a shaft portion 54, the dust particles adhering to the surface 54a of the shaft portion 54 can be removed by the cleaning-film portion 104 with a smaller width.

FIG. 5B shows another configuration in which a substrate film 102a has a cleaning-film portion 106 with a larger width than the product-film portion 94.

The cleaning-film portion 106 has the same functions and is made of the same material as the cleaning-film portion 92 of the substrate film 91 shown in FIG. 2.

The cleaning-film portion 106 is composed of a broad part 106a with a larger width than the product-film portion 94, and a joint part 106b connecting the broad part 106a and the product-film portion 94 with each other.

The cleaning-film portion 106 with a larger width can remove dust particles from a wider area than the area through which the product-film portion 94 passes. As a result, an even more clean environment is achieved in the interior of the film depositing apparatus 10.

In the configuration shown in FIG. 5C, a substrate film 102b has a cleaning-film portion 108 including both the cleaning-film portion 106 with a larger width than the product-film portion 94 and the cleaning-film portion 104 with a smaller width than the product-film portion 94. With such a configuration, the dust particles adhering to the two-diameter roller 50 of FIG. 6 are removed not only from the surfaces 52a of the roller portions 52 but the surface 54a of the shaft portion 54.

It should be noted that the substrate film 102 of FIG. 5A may have the leader film 96 provided at the front end of the cleaning-film portion 104, the substrate film 102a of FIG. 5B may have the leader film 96 provided at the front end of the cleaning-film portion 106, and that the substrate film 102b of FIG. 5C may have the leader film 96 provided at the front end of the cleaning-film portion 108.

In the present invention, the film to be deposited is not particularly limited, and films having the required functions, which depend on the functional films to be produced, can be formed appropriately. The method of depositing such a film is not limited to CVD processes as long as it is based on the vapor deposition.

The thickness of the film to be deposited is not particularly limited, either. The thickness may be determined as appropriate for the performance required by the functional film to be produced.

In addition, the film to be deposited is not limited to one in number, but two or more films may be deposited in layers. If a plurality of films are to be formed, the individual films may be the same or different from each other.

In the present invention, if a film is to be deposited on the inorganic film previously deposited, the cleaning layer 100 or layers 100 and 100a may additionally be formed in the front region of the substrate film constituting the film roll after film deposition 110 that has the inorganic film formed thereon, as shown in FIG. 3B or 3C.

In the present invention, if a gas barrier film (water vapor barrier film) is to be produced as the functional film, an inorganic film such as a silicon nitride film, an aluminum oxide film or a silicon oxide film is deposited on the substrate film irrespective of which is chosen for use from among the substrate films 91, 91a to 91e, 102, 102a and 102b as described above.

If protective films for a variety of devices or apparatuses including display devices such as organic EL displays and liquid-crystal displays are to be produced as the functional film, an inorganic film such as a silicon oxide film is deposited.

Further in addition, if the functional film to be produced is an optical film such as an anti-light reflective film, a light reflective film, and various filters, a film having the desired optical characteristics or a film made of materials that exhibit the desired optical characteristics is deposited.

While the film roll and the method of cleaning a film depositing apparatus of the present invention have been described above in detail, the present invention is by no means limited to the foregoing embodiments and it should be understood that various improvements and modifications are possible without departing from the scope and spirit of the present invention.

What is claimed is:

1. A film roll comprising an elongated substrate film for film deposition wound into a roll, the substrate film including:
at least one elongated product-film portion having a pair of surfaces opposite with each other, with one of the surfaces serving as a surface for film deposition; and
at least one cleaning-film portion connected to an end of the product-film portion and having a pair of surfaces opposite with each other, with at least one of the surfaces serving as a cleaning surface having a dust removal function.

2. The film roll according to claim 1, wherein one of the surfaces of said cleaning-film portion which is on the same side as the surface for film deposition of said product-film portion serves as the cleaning surface.

3. The film roll according to claim 1, wherein both of the surfaces of said cleaning-film portion serve as the cleaning surface.

4. The film roll according to claim 1, wherein said cleaning-film portion comprises an adhesive tape joined to the end of said product-film portion.

5. The film roll according to claim 1, wherein said product-film portion and said cleaning-film portion have a common base film comprising a resin film with a pair of surfaces opposite with each other, and
said cleaning-film portion includes an adhesive layer formed on at least one of the surfaces of the base film.

6. The film roll according to claim 1, wherein said product-film portion is composed of a base film comprising a resin film, and a thin layer of organic matter formed on the base film.

7. The film roll according to claim 1, wherein said cleaning-film portion is located near to an outer periphery of the roll as compared with said product-film portion.

8. The film roll according to claim 1, wherein said substrate film includes a plurality of the product-film portions, and said cleaning-film portion is interposed between the product-film portions.

9. The film roll according to claim 1, wherein said cleaning-film portion is located near to an inner periphery of the roll as compared with said product-film portion.

10. The film roll according to claim 1, wherein said substrate film further includes a leader-film portion connected thereto on an outer periphery of the roll.

11. The film roll according to claim 10, wherein said leader-film portion has a larger length than a transport path in a film depositing apparatus used for film deposition.

12. The film roll according to claim 1, wherein said cleaning-film portion has a larger width than said product-film portion.

13. The film roll according to claim 1, wherein said cleaning-film portion has a smaller width than said product-film portion.

14. A method of cleaning a film depositing apparatus for forming a specified film on a surface of an elongated substrate film in an atmosphere under vacuum while transporting the substrate film in its longitudinal direction by means of path rollers, comprising:
using the film roll of claim 1; and
transporting said cleaning-film portion of the substrate film of the film roll by means of the path rollers to thereby clean the path rollers.

15. The method of cleaning a film depositing apparatus according to claim 14, wherein said cleaning-film portion is transported at a lower speed than said product-film portion.

16. The method of cleaning a film depositing apparatus according to claim 14, wherein said cleaning-film portion is transported under a higher tension than said product-film portion.

17. The method of cleaning a film depositing apparatus according to claim 14, wherein said cleaning-film portion is transported after pressure is reduced in said film depositing apparatus.
